(19) United States
(12) Patent Application Publication
(10) Pub. No.: US 2016/0139258 A1
(43) Pub. Date: May 19, 2016

(54) PORTABLE MICROWAVE FREQUENCY IMAGING DEVICE, SYSTEM COMPRISING SUCH A DEVICE AND CORRESPONDING IMAGING METHOD

(71) Applicant: MICROWAVE CHARACTERIZATION CENTER, Sainghin en Melantois (FR)

(72) Inventors: Nicolas VELLAS, RICHEBOURG (FR); Nicolas THOUVENIN, FACHES-THUMESNIL (FR); Christophe GAQUIERE, VILLENEUVE D' ASCQ (FR); Sylvain JONNIAU, CROIX (FR); Florent CLEMENCE, BUYSSCHEURE (FR); Matthieu WERQUIN, Seclin (FR)

(21) Appl. No.: 14/899,158

(22) PCT Filed: Jun. 17, 2014
(86) PCT No.: PCT/FR2014/051499

§ 371 Date: Dec. 17, 2015

(30) Foreign Application Priority Data
Jun. 18, 2013 (FR) 1355722

(51) Int. Cl. G01S 13/88; G01S 13/86; G01S 7/06; G01S 13/89

(52) U.S. Cl. CPC G01S 13/887; G01S 13/89; G01S 13/867; G01S 7/06

(57) ABSTRACT

The present invention provides a portable imaging device 1 comprising a housing 2 and a microwave sensor 3 mounted in the housing 2. The device 1 also comprises first connection means for connecting the imaging device 1 to movement measuring means 4, and second connection means for connecting the imaging device 1 to a processor unit 5.

During movement of the housing 2, the processor unit 5 is configured to act in iterative manner to form a microwave image by:
detecting a determined movement of the detection zone of the sensor 3;
adding an additional pixel to the microwave image, which pixel is positioned relative to the preceding pixel as a function of said detected movement; and
giving said additional pixel a value of the signal of the sensor.

The invention also provides an imaging system including such an imaging device 1 and a corresponding imaging method.

### BACKGROUND OF THE INVENTION

The present invention relates to a portable imaging device, to a system including such a device, and to a corresponding imaging method. The present invention relates in particular to microwave imaging, and in particular to radiometric imaging.

In particular, an object of the invention is to make it possible, in reliable and easy manner, to detect objects carried by passengers or contained in luggage.

Security requirements have increased with the increase in risks, in particular risks of attack. A certain number of detection systems have thus been developed, or are in the process of being developed, in order to satisfy those requirements.

Active systems thus exist that make it possible to produce images at distances of less than 1 meter (m). Such systems, e.g. airport walk-through scanners, use radiometry in order to detect any (metal or other) item worn by passengers, in particular under clothing, with a resolution of less than 1 centimeter (cm). Such systems include a large number of sensors associated with a scanner system, making it possible to scan a person completely in a minimum amount of time and at close range. However, such devices are voluminous and can be difficult to move.

Passive mobile systems also exist that make it possible to produce images at distances of less than about 10 m. Such systems are transportable and they reveal items that people hide under their clothing, with a resolution lying in the range 1 cm to 10 cm, or they enable the contents of luggage left unattended to be scanned. Such systems include a much smaller number of sensors than that in the above-described active systems, and they are associated with a mechanical scanner system that makes it possible to scan a greater or smaller surface area. However, such systems, although transportable, remain difficult to move, which increases the time taken to intervene at a distant location.

Thus, there does not exist a portable detection device, in particular a device that can be held in one hand, that makes it possible to scan clothing worn by an individual, or even a mapping device for quickly mapping the contents of luggage left unattended in a public place, such as a station or an airport.

However, the development of such a device needs to satisfy mutually incompatible requirements, such as firstly high spatial resolution, and secondly a low noise factor or a considerable detection depth for the sensor, or even thirdly an optical system that is compact and lightweight, and fourthly low electricity consumption or small heat losses.

### OBJECT AND SUMMARY OF THE INVENTION

The present invention seeks to remedy the various technical problems mentioned above. In particular, the present invention seeks to propose a portable device that makes it possible to obtain the desired penetration depth, spatial resolution, size, and electricity consumption.

Thus, the present invention seeks to propose a detection device that makes it possible to see items through various materials (e.g. plastics materials, paper, fabric, wood, . . . ), presenting a spatial resolution of less than 1 m, preferably less than 50 cm, and more preferably less than 2 cm, presenting a weight of less than 5 kilograms (kg), preferably less than 3 kg, and more preferably less than 1 kg, having an image-reconstruction speed that is fast, and electricity consumption that is low. Thus, in an aspect, there is provided a portable imaging device, in particular a manual scanner device, comprising a housing and at least one microwave sensor, preferably a radiometric sensor, mounted in the housing. The microwave sensor is configured to pick up electromagnetic radiation emitted or reflected by a body or an item in a detection zone of the microwave sensor, and to transform it into a first signal that is representative of said radiation. The device also comprises:
first connection means for connecting the imaging device to movement measuring means, the movement measuring means being configured to deliver a second signal that is representative of the movement of the detection zone; and
second connection means for connecting the imaging device to a processor unit, the processor unit receiving, as input, the first signal and the second signal, and being configured to form, and possibly display on a display, a microwave image that is constituted by pixels.

During movement of the housing in order to cause the detection zone to scan points of a body or an item, the processor unit is configured to act in iterative manner to form, and possibly display, said microwave image by:
detecting, from the second signal, a determined movement of the detection zone between a first position and a second position;
adding an additional pixel to the microwave image, which pixel is positioned relative to the preceding pixel as a function of said detected movement; and
giving said additional pixel a value of the first signal as determined when the detection zone is in the second position.

Thus, by using movement measuring means, it is possible to reconstruct a microwave image from signals provided by the sensor(s). In particular, each of the various measurements taken by the sensor are used to form a different pixel of the microwave image, the pixels being positioned relative to one another by using the data from the movement measuring means.

In particular, the processor unit is configured to modify the size, and possibly the position, of the pixels of the image, in particular while adding an additional pixel. The pixels that are already displayed thus become smaller as scanning proceeds, and they are rearranged in the image as a function of the position of the added additional pixels.

The term “microwave sensor”, and in particular “radiometric sensor”, is used to designate a sensor that is capable of measuring electromagnetic frequencies that lie in the range 10⁷ hertz (Hz) to 10¹⁴ Hz, preferably in the range 10⁹ Hz to 10¹³ Hz.

Preferably, the device includes one to ten microwave sensors, preferably a single microwave sensor. The use of movement measuring means makes it possible to reconstruct an image from a limited number of sensors. In particular, the use of a small number of sensors, and in particular of a single sensor, makes it possible to obtain a more lightweight device and a saving in terms of energy.

Preferably, the microwave sensor is a radiometric sensor. The microwave image could then also be referred to as a “radiometric image”.

The detection zone is caused to scan points of a body or an item, preferably by the housing being moved manually. The use of movement measuring means makes it possible to avoid using mechanical scanner means that are complex, heavy, and bulky. The imaging device is thus moved by hand by the operator in such a manner that the detection zone of the sensor scans the body or item to be inspected.

Preferably, the movement measuring means comprise an inertial unit. The inertial unit may comprise three gyroscopes, three accelerometers, and three magnetometers in order to measure linear and rotational movements relative to three spatial directions, and thus determine, in real time, the position of the detection zone of the sensor over the scanned body or item.

Preferably, the second signal corresponds to a movement of the sensor, and in particular of a detection antenna of the sensor.

Preferably, the first and second connection means form single connection means. The single connection means thus make it possible to connect the portable imaging device to an external device comprising movement measuring means and a processor unit, e.g. a computer embedded in a telephone or smartphone. The external device is preferably securely mounted on the housing of the imaging device, so that the movement measuring means of the external device can measure the movements of the sensor of the imaging device.

Preferably, the housing also includes a camera that is configured to pick up the visible radiation emitted by or reflected from the detection zone, and in order to transform it into a third signal that is representative of said radiation, and the processor unit is configured to: form a visible image corresponding to the third signal; superpose the microwave image and the visible image; and possibly modify a portion of said microwave image. In combination with the microwave image, the visible image is used to improve the detection of hidden items and/or to prevent abuses in use and to protect human dignity. The microwave image could thus be used to detect such items and it is superposed on the visible image.

Preferably, the determined movement is substantially equal to the size of the detection zone.

In an embodiment, the sensor is configured to pick up collimated radiation, and the size of the detection zone is equal to the size of the collimated radiation.

In another embodiment, the housing or the movement measuring means further comprises measuring means for measuring the distance between the microwave sensor and the body or the item, and the size of the detection zone is determined as a function of the distance measured between the microwave sensor and the body or the item. In order to know the size of the detection zone when using focused radiation, it is necessary to know the distance between the body or the item and the sensor. The sensor may be an infrared sensor or any other distance sensor.

Preferably, the processor unit is mounted in the housing.

Preferably, the movement measuring means are mounted in the housing.

In particular, by incorporating the processor unit, the movement measuring means, and possibly also the display means in the imaging device, it becomes possible to obtain an imaging device that is complete and cordless, and that can be used directly and quickly by an operator.

In another aspect, the invention also provides an imaging system comprising an imaging device as described above, a processor unit, and movement measuring means for measuring the movement of the sensor. In this other aspect, the processor unit and the movement measuring means may be separate from the imaging device.

Preferably, the processor unit and/or the movement measuring means for measuring the movement of the sensor is/are mounted in a computer, possibly a laptop computer, or a mobile telephone. In order to limit the electricity consumption of the imaging device resulting from data processing, the processor unit may be separate from the imaging device. The data may then be sent to the processor unit via a cable or a wireless connection (of Wi-Fi or Bluetooth type), and the processed data can then be sent back to the imaging device so as to enable it to be displayed, for example.

In another aspect, the invention also provides a microwave-imaging scanning method, in particular a manual scanning method comprising:
an acquisition step for acquiring microwave electromagnetic radiation emitted by a body or an item in a detection zone, so as to deliver a first signal that is representative of said radiation;
a movement measuring step for delivering a second signal that is representative of the movement of the detection zone; and
a formation step for taking both the first signal and the second signal and forming therefrom a microwave image constituted by pixels, for displaying by a display.

In particular, while using the detection zone to scan points of a body or an item, the method comprises acting progressively and in iterative manner to form, and possibly display, said microwave image by:
detecting, from the second signal, a determined movement of the detection zone from a first position to a second position;
adding an additional pixel to the microwave image, positioned relative to the preceding pixel as a function of said detected movement; and
giving said additional pixel a value of the first signal when the detection zone is in the second position.

Thus, during the scanning of a body or an item, the various pixels for forming the microwave image of the scanned body or item are stored in succession.

In particular, the size, and possibly the position, of the pixels of the image are modified, in particular while adding an additional pixel. The pixels that are already displayed thus become smaller as scanning proceeds, and they are rearranged in the image as a function of the positions of the added additional pixels.

Preferably, the detection zone is caused to scan points of a body or an item by being moved manually.

Preferably, before the steps of progressively forming said microwave image, the method also comprises an initialization step in which the radiation emitted in the detection zone is measured so as to obtain a first value of the first signal, and a first pixel is formed in the microwave image with said value of the first signal.

Preferably, the scanning of points of the body or the item is stopped when the microwave image as formed shows the desired portion of the body or the item.

### BRIEF DESCRIPTION OF THE DRAWINGS

The invention and its advantages can be better understood on reading the detailed description of three particular embodiments, given by way of non-limiting example and shown by the accompanying drawings in which:

FIG. 1 is a diagrammatic view of a first embodiment of an imaging device of the invention;

FIG. 2 is a diagrammatic view of a second embodiment of an imaging device of the invention;

FIG. 3 is a diagrammatic view of a third embodiment of an imaging device of the invention;

FIGS. 4A to 4D show the successive microwave images as formed and possibly displayed during scanning in accordance with the invention; and

FIG. 5 shows an example of a flowchart of an implementation of a method of the invention.

### DETAILED DESCRIPTION OF THE INVENTION

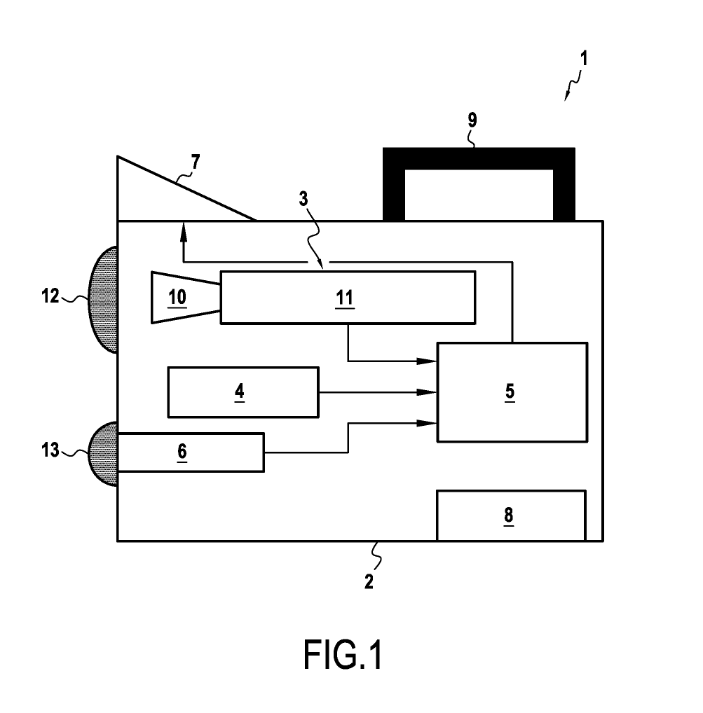

FIG. 1 is a diagram showing a first embodiment of an imaging device 1 of the invention.

In the first embodiment, the imaging device 1 comprises a housing 2 with a receiver 3, movement measuring means 4, and a processor unit 5. The imaging device 1 also comprises a camera 6 that is suitable for detecting visible radiation, and display means 7 for displaying the image of the scanned item. Finally, the imaging device also comprises a battery 8 and a handle 9, enabling it to be cordless and portable for easy and rapid use.

The sensor 3 is a microwave sensor. The sensor 3 may be active or passive. In particular, the sensor 3 may be a passive radiometric sensor that measures a Gaussian noise signal that corresponds to the radiation emitted by bodies having a temperature that is different from zero degrees kelvin. Alternatively, the sensor 3 may be an active sensor that emits a signal, e.g. a noise signal, towards the body in order to increase the sensitivity and/or the accuracy of the measurement performed by the sensor 3. Alternatively, the sensor 3 may be an active sensor that emits a known periodic signal towards the body, and in which the sensor determines the differences in amplitude and in phase between the measured signal and the emitted signal.

In the embodiment described below, it is assumed that the sensor 3 is a radiometric sensor or radiometer. In particular, the sensor 3 comprises an antenna 10 for picking up the radiation to be detected, and a receiver 11 that processes the radiation picked up by the antenna and that delivers a first signal that is representative of said radiation. Optionally, a lens 12, specific to the radiometric sensor, may be provided in the imaging device between the antenna and the body or the item to be scanned.

The receiver 11 may present various architectures depending on the technology used and/or on the measurement accuracy desired.

For a total power radiometer, which presents the simplest processing, the signal emitted by the body or the item and collected by the antenna 10 is amplified by a low noise amplifier (LNA). The amplified signal is processed by a band-pass filter and then by a square-law detector, making it possible to transform the power of the amplified and filtered signal into a voltage that is almost constant (a direct current or DC voltage). The voltage is thus smoothed by an analog or digital integrator so as to optimize sensitivity. Compared to other radiometers, a total power radiometer is the most sensitive since the antenna is connected directly to the amplifier, but it needs to be calibrated frequently so as to minimize variations in gain and in noise temperature.

A Dicke radiometer makes it possible to limit the problem of stability resulting from variations in gain. In a Dicke radiometer, variations in gain are compensated by periodic calibration, at a given frequency, at the inlet of the receiver by means of a reference load, comparable to a noise source, that is associated with a synchronous detector. The radiometer thus makes it possible to measure the difference between the temperature of the antenna and the equivalent noise temperature of the reference load. The receiver takes measurements in alternation, at the given frequency, either on the antenna or on the reference. The output voltage thus no longer depends on the noise temperature of the system, but it remains dependent on the gain of the system, and the sensitivity of the radiometer is halved compared to the total power radiometer.

A noise-addition radiometer also makes it possible to reduce the impact of variations in gain. A noise-addition radiometer includes a directional coupler that is connected between the antenna and the LNA, the directional coupler serving to inject noise from a reference that is operated at a given frequency. The receiver takes measurements in alternation, at the given frequency, with or without noise from the reference. The output voltage thus no longer depends on the gain.

A noise-injection radiometer is a combination of the Dicke radiometer and the noise-addition radiometer. The injected-noise level is adjusted by a feedback loop, so as to obtain an output voltage from the receiver that is zero.

A two-reference radiometer presents the distinctive feature of being relatively insensitive to the equivalent noise temperature of the receiver, and to the variations in detector gain and sensitivity. The radiometer includes two references, and a switch that is connected between the antenna and the LNA. The switch makes it possible to measure, in alternation, the temperature of the antenna or of one of the two references. By appropriately selecting the two references, the two-reference radiometer can offer performance that is clearly greater than the performance of the Dicke radiometer.

Finally, other types of radiometer architecture exist, such as: correlation architectures, interferometric architectures, pulsed-noise-injection architectures, Hach architectures, Graham architectures, . . . , and combinations of such architectures.

Whatever its structure, the receiver 11 may be based on homodyne or heterodyne detection.

Finally, depending on circumstances, the receiver 11 may also include a digital acquisition card that makes it possible to acquire data and to control various parameters.

The sensor 3 thus provides a first signal that is representative of the radiation picked up by the antenna 10. The first signal is transmitted to the processor unit 5 that is connected to the sensor 3 via connection means, and in the present embodiment via a data transmission cable (not shown).

The movement measuring means 4 make it possible to measure the various movements of the housing to which they are mounted in secure manner, and thus to measure the various movements of the sensor 3. The movement measuring means 4 may thus be an inertial unit. An inertial unit may comprise three accelerometers, three gyroscopes, and three magnetometers, thus making it possible to measure the movements (in translation and in rotation) of the housing relative to three spatial directions.

The movement measuring means 4 thus provide a second signal that is representative of the movement of the detection zone of the sensor 3. The second signal is transmitted to the processor unit 5, which is connected to the movement measuring means via connection means, and in the present embodiment via a data transmission cable (not shown).

The processor unit 5 receives the first signal and the second signal and outputs a microwave image that is delivered to the display means 7. The microwave image is built up as the detection zone of the scanner 3 is used to scan the body or the item. More precisely, the processor unit associates each determined movement of the detection zone with a value of the first signal constituting a pixel of the microwave image and, as a function of the determined movement, this pixel is added to the microwave image. The image begins to be formed when the operator engages detection by the imaging device; then the operator scans the body or item to be inspected; and the image stops being formed when the operator stops detection by the imaging device. It should thus be understood that the microwave image is built up progressively: initially, the microwave image comprises only a single pixel (corresponding to the first value of the first signal), then additional pixels are added and they continue to fill out the microwave image until scanning stops. The microwave image is thus formed by the various added pixels.

Assuming that the acquisition period of the sensor 7 is 200 microseconds (μs), then a pixel is measured every 200 μs. In other words, the operator may move the imaging device very quickly so as to build up the image of the scanned item or body. In 2 seconds (s), the image may comprise as many as 10,000 pixels. If the user passes over the same zone of the body or the item several times, then the average of the measurements of each pixel corresponding to said zone could be taken, so as to increase the sensitivity of the measurement. Thus, when the operator moves the imaging device 1 so as to scan a surface, an additional pixel may be displayed every 200 μs; if the movement is slow, then a plurality of successive pixels may correspond to the same zone of the scanned body or item, and the average of the values of the pixels may be taken, so as to reduce the signal-to-noise ratio.

The developing microwave image may thus be transmitted to the display means 7 so as to be displayed, and so as to enable the operator to visualize the portion of the body or the item that has already been scanned.

The spatial resolution of the imaging device 1 is thus associated with the Airy pattern of the sensor. The radius of the Airy pattern is inversely proportional to the aperture of the lens of the sensor 3. Thus, when considering an aperture D of 10 cm and a frequency of the sensor of about 90 gigahertz (GHz), a radius of about 4 cm is thus obtained for the Airy pattern for a distance of 1 m between the body or item and the sensor 3. More precisely, two items are discernable if they are 4 cm apart.

Thus, when considering pixels of sides equal to the radius of the Airy pattern, the operator may set the imaging device 1 in such a manner that a determined movement of the detection zone through less than half the radius of the Airy pattern is averaged with the last saved pixel, and that a determined movement of the detection zone greater than half the radius of the Airy pattern is averaged with the next pixel, at a position relative to the preceding pixel that corresponds to a distance equal to the radius of the Airy pattern.

Scanning may be performed freely by the operator, provided that the movement measuring means 4 are capable of identifying the scanning movement. Thus, in a first scanning technique, the operator may move the imaging device 1, and thus the sensor 3, in a plane that is parallel to the surface of the body or the item to be scanned. The second signal then provided by the movement measuring means corresponds to a movement in translation, and the resulting microwave image thus has the shape of the path followed by the imaging device in the plane that is parallel to the surface of the scanned item or body.

Alternatively, the operator may keep the imaging device 1 at a given position, and scan the body or item merely by moving the handle. The data then transmitted by the movement measuring means 4 corresponds to movements both in rotation and possibly also in translation if the sensor is not located on one of the axes of rotation. In addition, in order to know the size of the surfaces that are scanned successively by the sensor 3, the imaging device 1 may also include a distance sensor (not shown) that makes it possible to determine the distance between the imaging device 1 and the scanned body or item. The distance sensor may be an infrared sensor, or a distance sensor that is incorporated in the camera 6.

For example, scanning that describes a square gives the microwave images shown in FIGS. 4A to 4D in succession on a display screen. In FIG. 4A, the microwave image is formed of a single pixel (pixel 1) that is shown on the display screen, e.g. on the entire display screen. In FIG. 4B, the microwave image is made up of two first pixels (pixel 1 and pixel 2) that are shown on the display screen. Then, the microwave image is made up of three pixels that are displayed (pixel 1, pixel 2, and pixel 3), the remainder of the display screen being “inactive”. Finally, in FIG. 4D, scanning is terminated and the screen displays all four pixels (pixel 1, pixel 2, pixel 3, pixel 4) showing the entire scanned body or item and forming the final microwave image.

Alternatively, if an operator scans a body or an item by moving the detection zone of the sensor in such a manner as to trace a “Z” over the body or the item to be scanned, then the pixels of the microwave image are arranged in the microwave image in such a manner as to trace a “Z” likewise (the remainder of the screen being inactive).

Finally, in order to improve the detection of items on the scanned body, and in order to protect the privacy of the scanned person, the imaging device 1 includes the camera 6 that is suitable for picking up visible radiation. The camera 6 may be a conventional camera formed of photosensitive cells as can be found in digital cameras. A lens 13 may be provided in the imaging device 1, in front of the lens of the camera 6, so as to improve the optical properties of the camera. The signals from the camera are transmitted to the processor unit 5 that is connected to the camera via connection means, and in the present embodiment via a data transmission cable (not shown). The processor unit may then superpose the images obtained both by the sensor 3 and by the camera 6, so as to obtain an image that is more complete and that is easier for the operator to analyze.

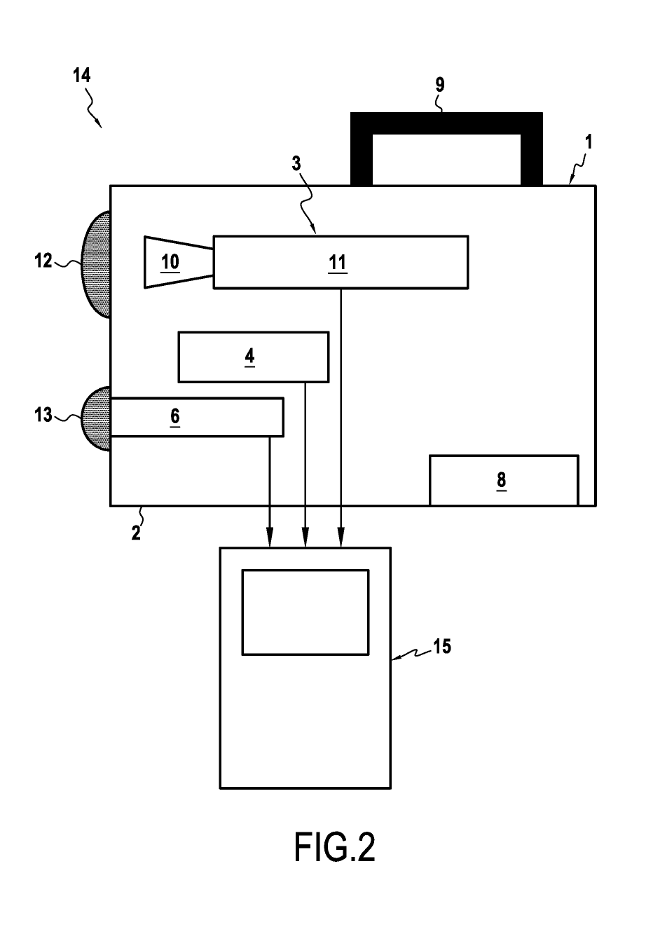

FIG. 2 shows a second embodiment of the invention in which the references that are identical to the references in FIG. 1 designate the same elements. FIG. 2 shows an imaging system 14 including an imaging device 1. In the imaging system 14, the processor unit, and possibly the display means, are no longer located inside the housing 2 of the imaging device 1, but are incorporated in an external device 15, e.g. a computer, connected to the imaging device 1.

The imaging device 1 thus includes connection means for connecting the imaging device 1 to the external device 15. The connection means may be a data transmission cable, or indeed a wireless connection that makes it possible to communicate data between the imaging device 1 and the external device 15. For the embodiment shown in FIG. 2, the external device 15 makes it possible to process the first signal and the second signal provided by the movement measuring means 4 and the sensor 3, and also the signal from the camera, and to provide the microwave image. The external device 15 may also include display means, e.g. a screen, making it possible to see the microwave image. Alternatively, the external device 15 may include connection means for transmitting the microwave image to display means that are incorporated in the imaging device 1.

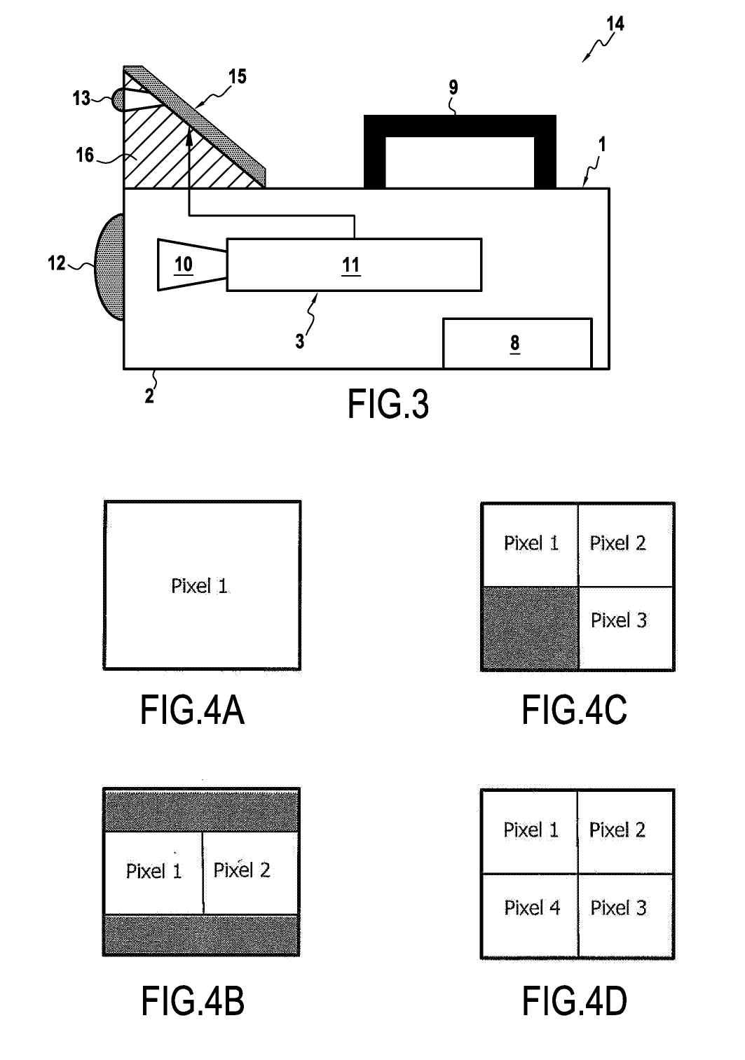

FIG. 3 shows a third embodiment of the invention in which the references that are identical to the references in FIGS. 1 and 2 designate the same elements. FIG. 3 shows an imaging system 14 comprising an imaging device 1 and an external device 15, e.g. a smartphone or an electronic device such as a tablet, arranged on the imaging device 1. In the imaging system 14, the processor unit, the movement measuring means, the camera, and the display means are no longer located inside the housing 2 of the imaging device 1, but are incorporated in an external device 15.

In particular, since the external device 15 is secured to the housing 2 of the imaging device 1 during scanning, the movement measuring means incorporated in the external device 15 are suitable for determining the movement of the sensor 3. In order to know the exact position of the external device 15 relative to the sensor 3, a support 16 may be provided on the housing 2, so as to position the external device 15 in unique and known manner on the housing 2. The support 16 may also include the connection means that make it possible to connect the imaging device 1 to the external device 15, and an optical guide, e.g. associated with the lens 13, making it possible to use the camera of the external device 15 to pick up the visible radiation from the detection zone.

For the embodiment shown in FIG. 3, the external device 15 makes it possible to process the first signal supplied by the sensor 3, and to measure the movement itself, and possibly the visible radiation from the detection zone, so as to then process the data and form the microwave image. The external device 15 may also include display means, e.g. the touchscreen of the smartphone, making it possible to see the microwave image.

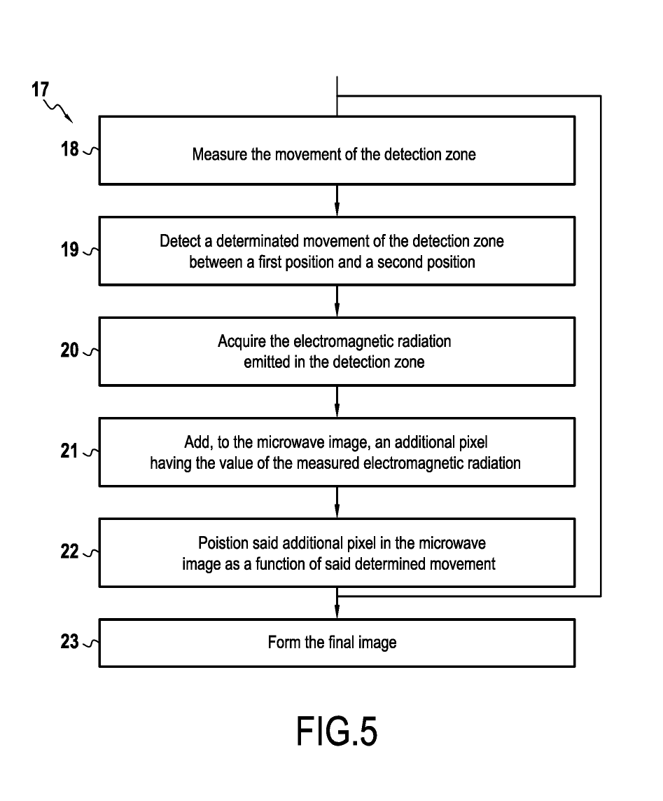

FIG. 5 shows a flowchart of an implementation of an imaging method 17 of the invention. The imaging method 17 thus comprises a first step 18 of measuring the movement of the detection zone. In a second step 19, the method detects a determined movement between a first position and a second position, and, in a third step 20, it acquires the electromagnetic radiation emitted in the detection zone. In a fourth step 21, an additional pixel is then added to the microwave image, the additional pixel having the value obtained during the acquisition of step 20. During a fifth step 22, the additional pixel is then placed in the microwave image as a function of the movement determined in step 19.

Some of the steps 18 to 20 may be performed in a different order or simultaneously, depending on the selected implementation.

The method 17 then begins again at step 18, until the scanning of the body or the item is finished. In step 23, the various resulting pixels thus make it possible to obtain a final microwave image.

Thus, the purpose of the invention is to make it easy, by means of a portable device, in particular a device that can be held in one hand, to obtain a microwave image of an item or a body that might present a risk. The imaging device also makes it possible to center the scanning on a very specific zone of the body or the item, thus limiting the duration of the scanning and the processing time of the image.

1-14. (canceled)

15. A portable imaging device comprising a housing and at least one microwave sensor mounted in the housing, the microwave sensor being configured to pick up electromagnetic radiation emitted or reflected by a body or an item in a detection zone of the microwave sensor, and to transform it into a first signal that is representative of said radiation;
wherein the device also comprises:
first connector configured to connect the imaging device to movement measurement unit, the movement measurement unit being configured to deliver a second signal that is representative of the movement of the detection zone; and
second connector configured to connect the imaging device to a processor unit, the processor unit receiving, as input, the first signal and the second signal, and being configured to form a microwave image that is constituted by pixels; and
wherein, during movement of the housing in order to cause the detection zone to scan points of a body or an item, the processor unit is configured to act in iterative manner to form said microwave image by:
detecting, from the second signal, a determined movement of the detection zone between a first position and a second position;
adding an additional pixel to the microwave image, which pixel is positioned relative to the preceding pixel as a function of said detected movement; and
giving said additional pixel a value of the first signal as determined when the detection zone is in the second position.

16. A device according to claim 15, including one to ten microwave sensors.

17. A device according to claim 16, including a single microwave sensor.

18. A device according to claim 15, wherein the movement measurement unit comprise an inertial measurement unit.

19. A device according to claim 15, wherein the second signal corresponds to a movement of the sensor, and in particular of a detection antenna of the sensor.

20. A device according to claim 15, wherein the housing also includes a camera that is configured to pick up the visible radiation emitted by or reflected from the detection zone, and in order to transform it into a third signal that is representative of said radiation, and wherein the processor unit is configured to: form a visible image corresponding to the third signal; superpose the microwave image and the visible image.

21. A device according to claim 15, wherein the processor unit is mounted in the housing.

22. A device according to claim 15, wherein the movement measurement unit are mounted in the housing.

23. An imaging system comprising an imaging device according to claim 15, a processor unit, and movement measurement unit configured to measure the movement of the sensor.

24. An imaging system according to claim 23, wherein the processor unit and/or the movement measurement unit configured to measure the movement of the sensor is/are mounted in a computer, a laptop or a mobile telephone.

25. A microwave-imaging scanning method comprising:
an acquisition step for acquiring microwave electromagnetic radiation emitted by a body or an item in a detection zone, so as to deliver a first signal that is representative of said radiation;
a movement measuring step for delivering a second signal that is representative of the movement of the detection zone; and
a formation step for taking both the first signal and the second signal and forming therefrom a microwave image constituted by pixels, for displaying by a display;
wherein, while using the detection zone to scan points of a body or an item, the method comprises acting progressively and in iterative manner to form said microwave image by:
detecting, from the second signal, a determined movement of the detection zone from a first position to a second position;
adding an additional pixel to the microwave image, positioned relative to the preceding pixel as a function of said detected movement; and
giving said additional pixel a value of the first signal when the detection zone is in the second position.

26. An imaging method according to claim 25, wherein the detection zone is caused to scan points of a body or an item by being moved manually.

27. An imaging method according to claim 25, wherein, before the steps of progressively forming said microwave image, the method also comprises an initialization step in which the radiation emitted in the detection zone is measured so as to obtain a first value of the first signal, and a first pixel is formed in the microwave image with said value of the first signal.

28. An imaging method according to claim 25, wherein the scanning of points of the body or the item is stopped when the microwave image as formed shows the desired portion of the body or the item.

29. A device according to claim 15, wherein the processor unit is also configured to display on a display said microwave image, and wherein, during movement of the housing in order to cause the detection zone to scan points of a body or an item, the processor unit is configured to act in iterative manner to display said microwave image.

30. A device according to claim 20, wherein the processor unit is also configured to modify a portion of said microwave image.

31. An imaging method according to claim 25, wherein the method comprises acting progressively and in an iterative manner to display said microwave image.
